(19) United States
(12) Patent Application Publication
(10) Pub. No.: US 2025/0383071 A1
(43) Pub. Date: Dec. 18, 2025

(54) MECHANICAL TRIMMING TOOL FOR A DEVICE SUSPENDED FROM A STRUCTURE BY TWO MOUNT POINTS

(71) Applicant: Exposure Illumination Architects, Inc., Scottsdale, AZ (US)

(72) Inventor: Daniel SPIRO, Scottsdale, AZ (US)

(73) Assignee: Exposure Illumination Architects, Inc., Scottsdale, AZ (US)

(21) Appl. No.: 18/742,254

(22) Filed: Jun. 13, 2024

(51) Int. Cl. F21V 21/008; F16G 11/10; F16G 11/14; F21S 8/06

(52) U.S. Cl. CPC F21V 21/008; F16G 11/101; F16G 11/14; F21S 8/06

(57) ABSTRACT

A mechanical trimming tool is used to help in the installation of a suspended device, such as a luminaire. The tool includes an elongated horizontal structure with vertical extension members positioned at the elongated horizontal structure opposite ends, wherein the vertical extensions terminate at each end with a substantially horizontal tab. The tool also includes a depressible bar, a latching device, and a suspension cable coupled to at least two couplers that are mounted to a device below.

### CROSS-REFERENCE TO RELATED APPLICATION

The present application has common inventorship with, and contains subject matter related to that disclosed in U.S. patent application Ser. No. 18/401,448, U.S. patent application Ser. No. 18/433,140, and U.S. patent application Ser. No. 18/436,081 the entire contents of each of which being incorporated herein by reference.

### BACKGROUND

### Technical Field

The present disclosure relates to a mechanical trimming tool that enables suspending a device from two mounting points above to a specified mounting height while maintaining the device trimmed and plumbed.

### Discussion of Background

Devices suspended from an overhead structure (e.g., lights in a warehouse) are commonly suspended by a conduit, pendent, cord, chain, and/or a cable. Small devices are typically suspended by a single suspension element. Larger devices, odd shaped devices, and orientation specific devices often are suspected with a plurality of suspension elements. The suspended devices are typically required to be installed so as to be plumbed at a uniform mounting height. Furthermore, to satisfy aesthetic requirements to provide structural stability, devices with asymmetrical forms can be required to have a particular orientation such as parallel to the floor, or some other fixed angle of suspension with respect to the floor or ceiling.

Recent innovations in the field of building illumination have resulted in a new class of luminaires referred to as “orientation specific luminaires”. These luminaire classes require suspension from a support structure by at least two mounting points. This new luminaire class has given rise to a need, as recognized by the present inventor, for an installation tool that is configured to help expedite the mounting, plumbing and trimming of the orientation specific luminaire.

Today, as discussed in U.S. patent application Ser. No. 18/436,081, luminaire optics can be agnostic of the luminaire's physical form while directing light in an asymmetrical pattern onto vertical and/or horizontal surfaces. In addressing the luminaire's specific orientation needs, at least one orientation specific hub has been invented (see U.S. patent application Ser. No. 18/433,140) by the present applicant. The orientation specific hub can be coupled to a mechanical or an electromechanical device such as a luminaire. In at least one different embodiment, the orientation specific hub can be coupled to a luminaire/device support structure or a combined coupling to the support structure above and the suspended luminaire/device below.

The orientation specific device has introduced a new device concept for the construction industry. However, as recognized by the present inventor, the concept of the new device raises questions about means and methods of construction including establishing device mounting height, handling device weight, number of installers required for a device installation, and the production time for the device installation. Important factors to the efficiency of device mounting production include the device trimming, plumbing, and orientation. The present application shows and teaches of a tool called Mechanical Trimming Tool (MTT) that is configured in most two point mounting applications to enable a single installer mount a device from a support structure above.

### SUMMARY

The present disclosure shows the structures and teaches the use of a tool called “Mechanical Trimming Tool (MTT)” that is configured for most two point mounting applications to enable a single installer to mount a device from a support structure overhead.

### BRIEF DESCRIPTION OF THE DRAWINGS

A more complete appreciation of the disclosure and many of the attendant advantages thereof will be readily obtained as the same becomes better understood by reference to the following detailed description when considered in connection with the accompanying drawings, wherein:

FIGS. 1a and 1b respectively show a frontal view and a side view of an assembly having a support structure, a suspended lighting device, a MTT positioned in between the support structure and the suspended lighting device, and suspension cables extending from the support structure through the MTT coupling to the lighting device below.

FIG. 2 shows a frontal elevation of the MTT with suspension cables extending through the MTT.

FIG. 3 shows a longitudinal section through the mechanical trimming tool.

FIGS. 4a and 4b show a top view and a bottom view of the mechanical trimming tool.

FIG. 5 shows a top perspective view of the mechanical trimming tool.

FIG. 6 shows a bottom perspective view of the mechanical trimming tool.

FIGS. 7a, 7b, 7c, and 7d show a step-by-step process of suspending a device from a suspension cable.

### DETAILED DESCRIPTION

As used herein, an element or step recited in the singular and proceeded with the word “a” or “an” should be understood as not excluding plural elements or steps, unless such exclusion is explicitly recited. Furthermore, references to “one embodiment” of the present disclosure are not intended to be interpreted as excluding the existence of additional embodiments that also incorporate the recited features.

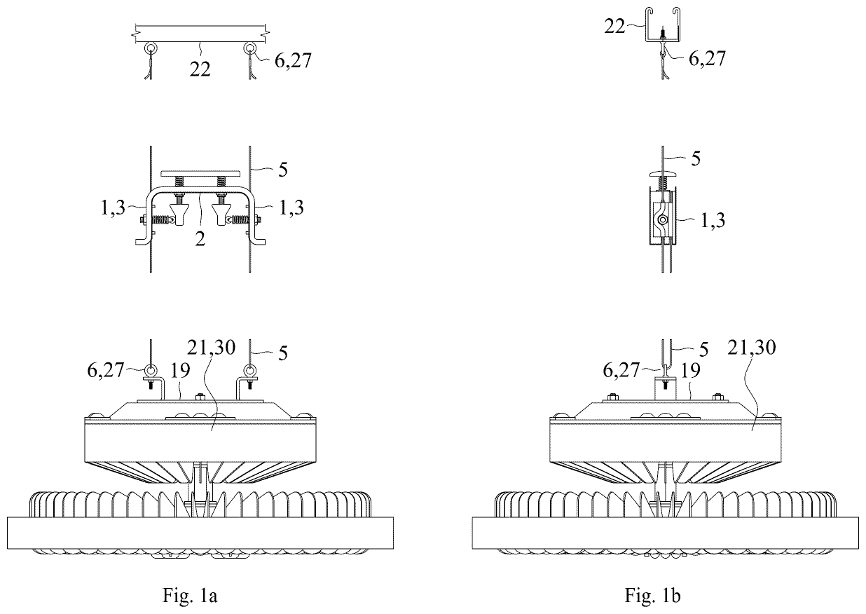

In reference to FIG. 1a and FIG. 1b, the MTT 1 is a tool that enables an installer to raise and lower a device 21, 30 (e.g., a luminaire) to a specified mounting height while the device 21, 30 remains plumb and trimmed. The MTT 1 is positioned below a support structure 22 above and a suspended device 21, 30 below. The suspended device 21, 30 can be coupled to an orientation specific hub 19. At least two mounting couplers 6 can be coupled to the surface of a device 21, 30 and/or to a surface of the orientation specific hub 19. At least one suspension cable 5 can couple the device to the support structure 22 above.

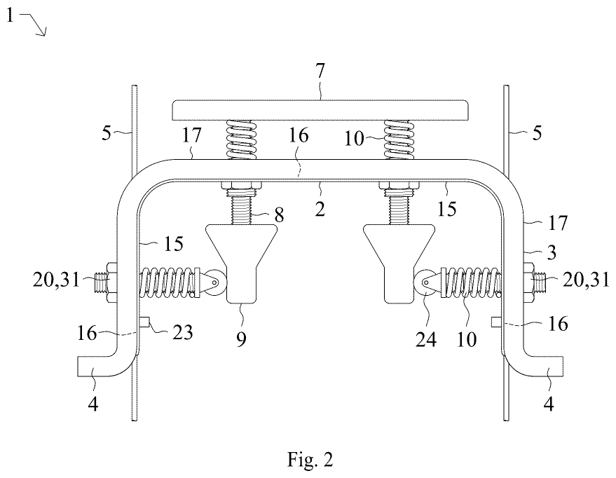

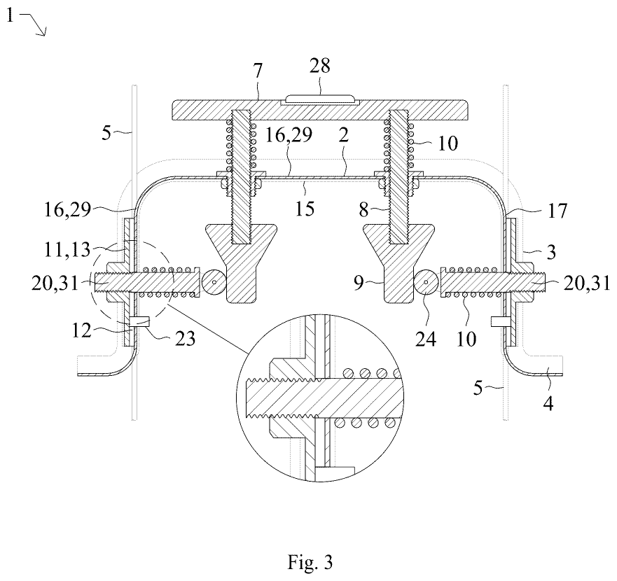

The MTT 1 includes an elongated horizontal structure 2 and vertical extension members 3 positioned at the opposite ends of the elongated horizontal structure 2 wherein the vertical extension members 3, in at least one embodiment, can terminate at each end with a substantially horizontal tab 4 (FIG. 2). In references to FIGS. 2 and 3, elements of the MTT 1 include a depressible horizontal bar 7 with at least one plunger extension 8 coupled to a plunger 9 below. The depressible bar 7 is positioned above the elongated horizontal structure 2 with a gap in between. The depressible bar 7 via the plunger 9 exerts vertical pressure on at least one mechanical pressure exerting latching device 31. The horizontally oriented mechanical pressure exerting latching device 31 converts the vertical pressure received to lateral pressure that is applied on the latching devices 11 pressed against the exterior side surfaces 29 of the vertical extension members 3. In one or more alternative embodiments, at least one protrusion (e.g., 2 or 3, or more) may be used alone or in combination with the latching device to increase frictional forces on at least one suspension cable so as to inhibit or stop the vertical mobility of the device coupled from below. Moreover, the at least one suspension cable is partially wound around one side of one protrusion (e.g., a left hand side of a first protrusion), and then partially wound around an opposite side (e.g., right hand side) of a second protrusion to impart a U shape, an S curve, or multiple U or S shape curves in the suspension cable, which boosts the frictional forces on the cable. The amount of frictional force is adjustable via the addition of one or more additional protrusions with each protrusion imparting another curve in the cable. The frictional forces may further be accentuated with friction-enhanced coatings on the contact surfaces of the protrusions. The friction-enhanced coatings have higher coefficients of friction than smooth metallic materials. For example, rubber or silicon coatings may be applied to the contact side of the protrusions, and/or abrasive coatings such as the equivalent of 10 to 200 grit sandpaper or emery cloth. Furthermore the frictional forces may further be adjusted by adjusting a pitch between adjacent protrusions, and thus impart a different angle in the cable relative to vertical.

The MTT 1 is configured to receive at least two suspension cables 5 from a support structure 22 above. A separation distance for mounting points for the cables 5 at the support structure 22 can be the same as the distance between the suspension cables 5's openings adjacent to the exterior side surfaces 29 of the vertical extension members 3. The suspension cables 5 extend downwardly through the openings adjacent to the vertical extension members 3. The suspension cables 5 continue extending downwardly through couplers 6 (e.g., FIG. 1a) that can be coupled directly or indirectly by means of an orientation specific hub 19 to a device 21, 30 below.

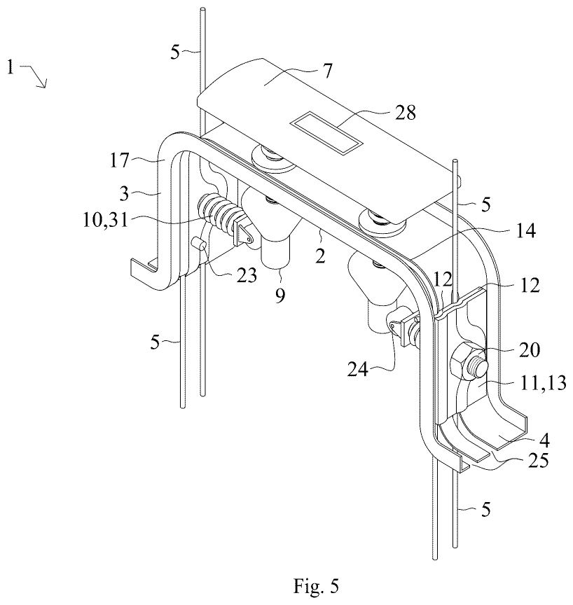

The suspension cables 5 exit the couplers 6 from another side, and then extend upwardly, entering different openings at the bottom of the mechanical trimming device 1. The section of the suspension cable 5 then extends upwardly through openings at the bottom of the MTT continuing along the exterior side surfaces 29 of the vertical extension members 3 and resting on the clongated horizontal structure's exterior side surface 29. In at least one embodiment, at least one channel 14 (e.g., FIG. 5) can be formed in at least one exterior side surface 29 of the mechanical trimming tool 1 to seat at least one suspension cable 5.

The MTT 1 can employ at least one depressible horizontal bar 7 with at least one vertical plunger extension 8 coupled below the elongated horizontal structure 2. A gap between the depressible bar 7 and the top surface of the elongated horizontal bar 2 is maintained by a pressure exerting device 10 disposed between. The pressure exerting device 10, e.g., as implemented with a spring, may impart may exert pressure from a resilient force imparted by the pressure exerting device 10. With pressure applied on the depressible horizontal bar 7, the plunger 9 moves downward exerting vertical pressure on a mechanical pressure exerting latching device 31 that in turn converts the applied pressure to lateral pressure that maintains coupled latching devices' 11 pressure against the exterior side surfaces 29 of the vertical extension members 3.

At the exterior side surfaces 29 of the vertical extension members 3, the mechanical pressure exerting latching device 31 is coupled to a latching device 11 that has a hardened backing surface 13 with non-slip material 12 coupled thereto. The hardened backing surface 13 can include at least one coupled guiding leader 23 that prevents the latching device 11 from rotating. The non-slip material 12 coupled to the hardened backing surface 13 is configured to maintain constant contact with the exterior side surface 29 of the vertical extension members 3 with the suspension cables 5, received from above and below, positioned in between. The pressure applied on the suspension cables 5 keeps the suspended device 21, 30 stationary.

Elevating or lowering the coupled device 21, 30 below is accomplished by applying downward pressure on the depressible bar 7. In reaction, the depressible bar plunger 9 then exerts pressure on a roller 24 that is coupled to mechanical pressure exerting latching devices that in turn open gaps between the latching device 11 non-slip material 12 surface and the exterior side surface 29 of the vertical extensions. In at least one embodiment, at least one of the profiles of the non-slip material 12 surface and the profile of the exterior side surface 29 of the vertical extension member 3 can have a channel 14 that is sized to enable maximum contact with a suspension cable 5 disposed between.

As described in the above example, the MTT allows for a suspended coupled device 21, 30 to remain stationary. The mechanisms of maintaining the coupled device 21, 30 stationary can vary; however, regardless of the mechanism to keep a coupled device stationary, the present innovation's utilities include at least one of:
a) A tool for trimming and plumbing a suspended device that is configured to lift and lower a suspended device by exerting pressure on a tool's lever.
b) A tool that enables lifting/lowering a suspended device to a specified mounting height, trimming, and plumbing in a one step process.
c) A way of trimming and plumbing a suspended device from two support mounting points above with a single suspension cable.
d) A way of trimming and plumbing a suspended device from two mounting points of an above support structure and two device mounting points on a device below wherein the device orientation remains permanent.
e) A tool for trimming and plumbing a suspended device wherein the tool is portable and reusable for trimming and plumbing with at least one other device.
f) A tool for trimming and plumbing a suspended device wherein the tool enables the installation process of the device to be accomplished by a single installer.

Upon trimming and plumbing a coupled suspended device at a specified mounting height, the last step includes securing the suspended cables to one another above each coupler. Securing the cables to one another can be accomplished by at least one aircraft cable fastener. Once secured in place, the cable section extending across the mechanical trimming tool can be cut and discarded. The mechanical trimming tool can be reused again.

### DETAILED DESCRIPTION WITH REFERENCE TO DRAWINGS

FIG. 1a shows an assembly having a support structure, a suspended lighting device, a MTT positioned in between, and suspension cables extending from the support structure through the MTT down, coupling to couplers that are coupled to a lighting device.

The suspended assembly shows a support structure 22 with two eye loop 27, as coupling devices 6, set apart from one another. Suspension cables 5 coupled to respective of the pair of eye loops 27 (also referred to as coupling devices 6) extend through openings in the mechanical trimming device 1 downwardly to couple to reciprocating eye loops 27 that are coupled to an orientation specific hub 19. The orientation specific hub 19 is shown coupled to a light emitting device 30. In a different embodiment, the coupling devices 6 couple directly to a surface of a device 21 below.

The mechanical trimming tool 1 can be coupled to the suspension cables 5 after a mechanical or an electromechanical device 21 is coupled. The suspension cable 5 can be a continuous cable that passes from one side of the MTT to the other as will be discussed in more detail below. The suspension cable 5 can originate from a first coupling device 6, 27 mounting point of the support structure 22, extending through one end opening of the mechanical trimming tool 1 adjacent to one side of a vertical extension member. The suspension cable then extends downwardly through a coupler 6 passthrough opening, exiting at the other side and then extending upwardly through a different opening at the bottom side of the mechanical trimming tool 1. The suspension cable then extends upwardly along the exterior surface of a vertical extension member 3 and the exterior surface of the elongated horizontal structure 2, and then extends downwardly along the exterior surface of the opposing side's vertical extension member 3. The suspension cable then exits an opening at the bottom of the vertical extension member, extending downwardly entering a passthrough opening of a different coupler 6. The suspension cable 5 then exits the coupler 6 at the other side, and extends upwardly through an opening at the bottom side of the mechanical trimming tool 1. Finally, the suspension cable 5 extends upwardly, adjacent to the vertical extension member 3 and connects to and along the exterior surface of the vertical extension member 3 to couple to a second coupling device mounting point 6, 27 of the support structure 22. A recommended distance between the suspension cables should be no less than the distance between the couplers 6 coupled to the device below.

FIG. 1b shows the same assembly as shown with FIG. 1a with the assembly rotated at 90°. Elements shown include: the support structure 22, the coupler 6, 27, the mechanical trimming tool 1, the suspension cable 5, the vertical extension member 3, the orientation specific hub 19, and the device/light emitting device 21, 30.

FIG. 2 shows a frontal elevation of the mechanical trimming tool 1 with suspension cables 5 extending through from above as well as from below. Moreover, FIG. 2 shows the mechanical trimming device 1 having three distinct sections: an elongated horizontal structure 2, vertical extension members 3, and tabs 4. The tabs 4 are not essential for the operation of the mechanical trimming tool. However, they can be useful in guiding the suspension cables 5 to their respective locations.

The pair of suspension cables 5 enter passthrough openings from above at opposite sides of the mechanical trimming tool 1. The suspension cables extend downwardly looping through coupling devices (discussed above with respect to FIG. 1a) extending upwardly to enter different passthrough openings from below at opposite sides of the mechanical trimming tool 1. During installation, two suspension cables 5 enter the mechanical trimming tool 1 from above and four suspension cables from below. Two of the four suspension cables entering from below wrap around the surfaces of the exterior sides 16 of the vertical extension members 3 and the clongated horizontal structure 2.

The mechanical trimming tool 1 material is sufficiently strong to execute the trimming or trimming and plumbing operation effortlessly. To increase rigidity, stiffeners 17 at both sides of the tool form a “U” shaped beam. A height and/or thickness and/or material of the stiffener 17 can correspond to offset the weight of the device coupled below.

Above the elongated horizontal structure 2 a depressible bar 7 shown is configured to enable retaining a device suspended below to remain stationary, until fasteners (not shown) secure device suspension cables 5 in place. Before the fasteners are installed, the depressible bar 7 enables setting the suspension cables 5 in place along the exterior surfaces of the mechanical trimming device 1 and raising/lowering the coupled device to its permanent mounting height.

Undisturbed, the depressible bar 7 extends above the elongated horizontal structure 2. FIG. 2 shows pressure exerting devices 10 in the form of springs maintaining the gap. In other embodiments, the gap can be maintained by other devices, such as foam pieces that have a resilient property. The plunger extensions 8 are positioned vertically (i.e., orthogonal to a horizontal plane of the main surface of the depressible bar 7) with respect to the depressible bar 7 with plungers 9 coupled at their bottom. When downward pressure is applied on the depressible bar 7, the plungers 9 exert vertical pressure on the rollers 24 of the mechanical pressure exerting latching device 31.

The mechanical pressure exerting latching device 31 redirects the vertical pressure applied from the above plungers 9 laterally. The latching device 31 includes a threaded rod with a roller 24 at the interior side of the mechanical trimming device 1 and a latching device 11 (not shown) at the opposite side being the exterior side 16 of the vertical extension members 3. The latching device assembly presses against the wall of the vertical extension member 3 from both sides and is secured by a bolt 20. FIG. 2 shows a pressure exerting device 10 in the form of a spring that maintains latching pressure on the latching device. The pressure applied by the latching device keeps the device suspended below stationary.

The latching device is disposed between the stiffeners 17 and can be formed as an elongated body. To avoid rotation, at least one guiding leader 23 built into the latching device is configured to prevent rotational mobility.

FIG. 3 shows a longitudinal section through the mechanical trimming tool. At the top of the depressible bar 7, an optional bubble level 28 is shown embedded inside the bar's handle. For reasons of brevity, the present narrative makes note of the elements described in FIG. 2 and expands on the elements and operational functionalities yet to be disclosed. The elements shown in FIG. 2 include the pressure exerting device 10, the elongated horizontal structure 2, the exterior side and surface 16, 29 of the mechanical trimming tool, the plunger extension 8, the plunger 9, the suspension cable 5, stiffeners 17, and the interior side of the mechanical trimming tool 15.

FIG. 3 also shows the elements of the mechanical pressure exerting latching devices 31. The mechanical pressure exerting latching devices 31 are horizontally oriented devices that couple the vertical extension members 3 of the mechanical trimming device 1. Each latching device 31 can comprise a threaded rod with a roller 24 at the interior side 15 of the mechanical trimming device 1 and a latching device 11 at the opposite side, being the exterior side 16 of the vertical extension members 3. The roller 24 is configured to redirect the vertical pressure applied by the plunger 9 laterally. The roller can have a recess at the contact point with the plunger 9. The latching device 11 is configured to press against the exterior wall of the vertical extension member 3 through pressure applied from inside the interior side 15. Both latching devices 11 are secured by nuts 20. FIG. 3 shows a pressure exerting device 10 in the form of a spring maintaining pressure on the latching device 11. The pressure applied by the latching device 11 on the two suspension cables 5 wedged between the latching device 11 and the exterior side surface 16, 29 of the vertical extension members' walls keeps a device suspended below stationary.

Latching devices 11 include a non-slip material 12 layer coupled to a hardened backing surface 13. The hardened backing surface 13 can include at least one guiding leader 23 that is configured to maintain the lateral and non-rotational latching device 11 movement when pressure is applied on the depression bar 7. The guiding leader 23 can extend through a bore in the wall of the vertical extension member 3. As shown, the travel distance of the latching device can be no less than the largest diameter of the suspension cable used, the gap between the side walls of the latching device 11, and the inner walls of the stiffeners 17.

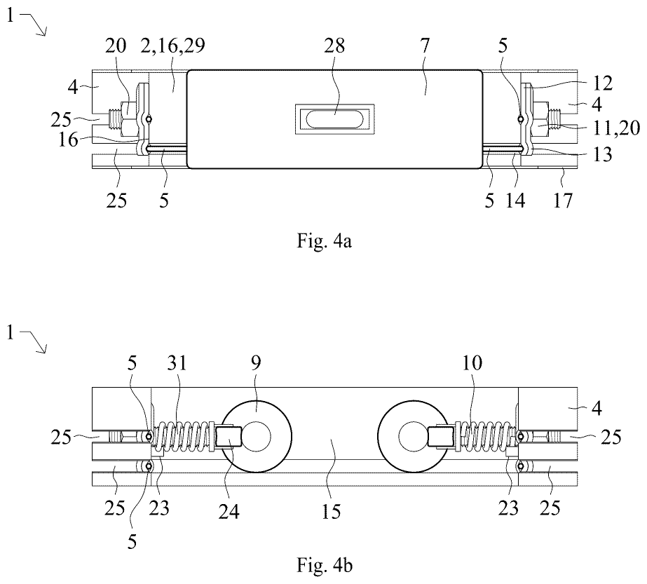

FIGS. 4a and 4b show a top view and a bottom view of the mechanical trimming tool, respectively.

FIG. 4a shows the top view of the mechanical trimming tool 1 with the depressible bar 7 above, and includes an optional bubble level 28 embedded inside the bar's handle. Below, the elongated horizontal structure 2, two parallel channels 14 are recessed in the exterior top surface 16, 29 of the horizontal structure 2 extending the longitudinal length of the elongated horizontal structure 2. At least one of the channels 14 is configured to receive a suspension cable 5 section that originates from below at both ends of the mechanical trimming tool 1.

At opposite ends of the mechanical trimming tool 1, tabs 4 with suspended cable insertion slots 25 are shown with a mechanical pressure exerting latching device 11 securing nut 20. The securing nut 20 secures the assembly including the non-slip material layer 12 coupled to the hardened backing material 13. A gap between the stiffeners' 17 inner walls and the latching device's hardened backing material 13 is configured to enable placing the suspension cable 5 between the surface of the non-slip material 12 and the exterior side surface 16 of the vertical extension member 3.

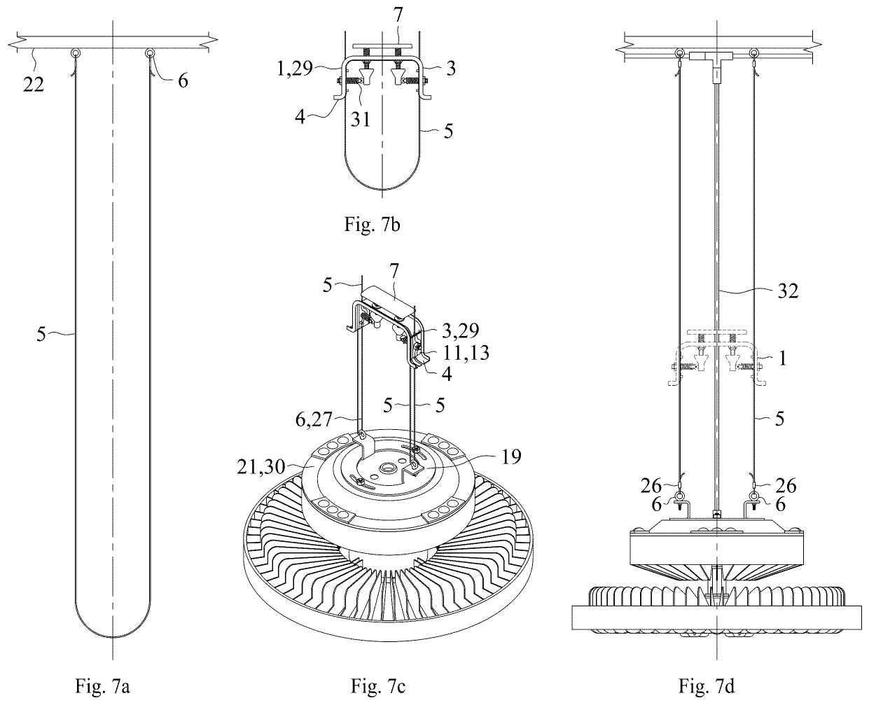

Although a detailed explanation will be provided of an installation process with reference to FIGS. 7a-d, a brief description on an aspect is provide with reference to FIGS. 4a and 4b. To insert a suspension cable 5, an installer inserts a suspension cable 5 through the insertion slot 25 and then between a stiffener's 17 inner wall and the side wall of the latching device. Then the installer places the suspension cable 5 between the non-slip material surface 12 and the exterior side wall 16 of the vertical extension member. In at least one embodiment, channel/s 14 in at least the non-slip material 12 surface and the exterior side surface 16 of the vertical extension member 3 is/are configured to receive a suspension cable 5.

FIG. 4b shows a bottom view of the mechanical trimming device 1. The bottom view shows the interior side 15 of the mechanical trimming device 1. At the center, plungers 9 are shown communicatively coupled to the rollers 24 of the mechanical pressure exerting latching device 31. Elements of the device 31 shown also include a pressure exerting device 10 in the form of a spring, and a latching device guiding leader 23. At the ends of the mechanical trimming device 1, the bottom side of a tab 4 is shown having two insertion slots 25 each and suspension cables 5 wedged in between the non-slip material 12 of a latching device 11 and an exterior side surface 29 of a vertical extension member 3.

FIG. 5 shows a top perspective view of the mechanical trimming tool 1. The elements shown include: a suspension cable 5, a latching device 11, a hardened backing surface 13, a nut 20, a vertical extension member 3 of the mechanical trimming tool 1, a tab 4, a plunger 9, an elongated horizontal structure 2 of the mechanical trimming tool 1, a roller 24, a mechanical pressure exerting latching device 31 with a pressure exerting device 10, a guiding leader 23, a suspension cable insertion slot 25, a stiffener wall 17, and above a depressible bar 7 with a coupled optional bubble level 28.

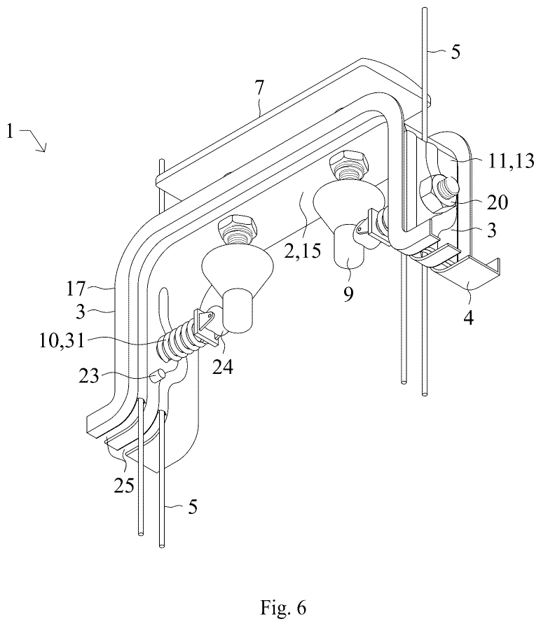

FIG. 6 shows a bottom perspective view of the mechanical trimming tool. The elements shown include: a suspension cable 5, a latching device 11, a hardened backing surface 13, a nut 20, a vertical extension member 3 of the mechanical trimming tool 1, a tab 4, a plunger 9, an elongated horizontal structure 2 of the mechanical trimming tool 1, an interior side 15 of the mechanical trimming tool 1, a roller 24, a mechanical pressure exerting latching device 31 with a pressure exerting device 10, a guiding leader 23, a suspension cable insertion slot 25, a stiffener wall 17, and above a depressible bar 7.

FIGS. 7a, 7b, 7c, and 7d show a step-by-step process of suspending a device from a suspension cable.

FIG. 7a shows a suspended device elevated support structure 22 with two couplers 6 mounted to the bottom surface of the support structure 22. A suspension cable 5 coupled to a first coupler 6 extends downwardly to a height below a specified mounting height for a designated device and then extends upwardly to couple to a second coupler 6. In this regard the cable 5 is continuous.

FIG. 7b shows a partial view of the bottom section of the suspended cable 5 with a mechanical trimming tool 1 coupled. The suspended cable/s 5 can be inserted through the insertion slots of the tabs 4 and then slipped between the latching device and the exterior side surface 29 of the vertical extension members 3 at the opposing sides of the mechanical trimming tool 1. For mechanical trimming tool 1 embodiments without tabs 4, the suspension cable/s 5 can be directly placed between the latching device and the exterior surface of the vertical extension members at opposing sides of the mechanical trimming tool 1.

Placing the suspension cable 5 in place requires an installer to exert pressure on the depressible bar 7. The pressure applied forces the latching device 11 of the mechanical pressure exerting latching device 31 to open a gap, enabling the placement of the suspension cable/s 5 to be slipped into their respective positions. In at least one embodiment, at least one exterior side surface 29 of at least one vertical extension member 3 can have a channel to which at least a portion of the suspension cable 5 couples. Similarly, at least one non-slip surface of at least one latching device can have a channel that at least a portion of the suspension cable 5 couples to.

At this step of installation, the latching devices of the mechanical trimming tool 1 firmly grips the two device suspension cables 5. The remaining section of the suspension cable 5 extends downwardly.

FIG. 7c shows how the remaining sections of the suspension cable 5 are coupled to the device's 21, 30 couplers 6. The couplers 6 can directly couple to a device 21, 30 or can couple to an orientation specific hub 19 as shown in the present figure. The present figure shows two open end eye loops 27 set apart from one another. Karabiners or other connectors may be used as well as an alternative to an open loop. It is recommended, although not essential, that the distance between the couplers 6 of the device be approximately the same as the distance between the exterior side surfaces 29 of the vertical extension members' 3 surfaces.

In FIG. 7c, the remaining section of the suspension cable 5 is inserted through both open eye loops 27. The jointed section enters each of the open eye loops 27 from one side and exits from the opposite side. Then, the section of cable 5 is oriented upwardly, through the openings at the bottom sides of the tab 4, continues to extend upwardly along the exterior side surfaces 29 of the vertical extension members 3, and rests on the exterior surface side 29 of the elongated horizontal structure 2. As with the suspension cable/s received by the mechanical trimming tool 1 from above, the suspension cables received from below can have dedicated insertion slots, passthrough openings, and channels. The latching devices 11 are configured to latch to both the suspension cables 5 received from above and from below.

With the suspension cable/s 5 from the above and from the below in place and the coupled device 21, 30 couplers 6 engaged, the trimming and plumbing mechanical trimming tool 1 is ready to position the coupled device 21, 31 at a specified mounting height. The installer then lowers the mechanical trimming tool 1 to an appropriate distance above the coupled device 21, 30 while maintaining the trimming tool 1 plumb. The installer then proceeds with raising or lowering the device to a specified device mounting height. In performing this step, the latching devices 11 of the mechanical trimming tool 1 are engaged to maintain the device's plumbed position.

FIG. 7d is the last installation step. In this step the installer fastens (e.g., by use of a cable clip clamp or a cable clip) to one another the two side by side suspension cables 5 of each coupler 6, optionally cuts and discards the suspension cable 5 section that extends through and across the mechanical trimming tool 1, and removes the mechanical trimming tool.

### ELEMENT LIST

1. Mechanical Trimming Tool
2. Elongated Horizontal Structure
3. Vertical Extension Member
4. Tab
5. Suspension Cable
6. Coupling Device
7. Depressible Bar
8. Plunger Extension
9. Plunger
10. Pressure Exerting Device
11. Latching Device
12. Non-slip Material
13. Hardened Backing Surface
14. Channel
15. Interior Side
16. Exterior Side Surface
17. Stiffener
18. Passthrough Opening
19. Orientation Specific Hub
20. Nut
21. Device
22. Support Structure
23. Guiding Leader
24. Roller
25. Insertion Slot
26. Fastener
27. Eye Loop
28. Bubble Level
29. Exterior Side Surface
30. Light Emitting Device
31. Mechanical Pressure Exerting Latching Device

1. A mechanical trimming tool for use in installation of a suspended coupled device, the mechanical trimming tool comprising:
at least two couplers each having a passthrough opening, the at least two couplers are set apart from one another and configured to be coupled to the suspended coupled device, the suspended coupled device being a mechanical or electromechanical device mounted below;
a suspension cable system that is coupled to the at least two couplers that are mounted to suspended coupled device below, cable segments of the cable suspension system respectively extend through the passthrough of a corresponding one of the at least two couplers;
an elongated horizontal structure has vertical extension members positioned at opposite ends thereof that are each terminated with a substantially horizontal tab having at least one passthrough opening, the elongated horizontal structure is disposed over the at least two couplers, the at least one passthrough opening sized to receive at least one cable segment from one of the at least two couplers below, at least another passthrough opening in the substantially horizontal tab is sized to receive at least another cable segment from above, at least one cable segment from one of the at least two couplers below extends across exterior surfaces of the elongated horizontal structure and the vertical extension members;
a depressible bar with a vertical plunger is positioned above the elongated horizontal structure, a mechanical pressure exerting device disposed between the depressible bar and the elongated horizontal structure maintains a gap between the mechanical pressure exerting device and the elongated horizontal structure, the vertical plunger extension extends below the elongated horizontal structure and is terminated with a plunger;
at least one mechanical pressure exerting latching device extends perpendicularly across a vertical extension member, at an exterior surface side of the vertical extension member the pressure exerting latching device is coupled to a non-slip clamp, at an interior side of the vertical extension member a pressure exerting device is configured to maintain contact between the non-slip clamp and the exterior surface of the vertical extension member so the non-slip clamp maintains the coupled suspended device stationary, the mechanical pressure exerting latching device terminates at the interior side of the vertical extension member with an area that contacts the plunger extension of the depressible bar, wherein
at least one cable segment received from above and a cable segment received from below is positioned between the exterior surface of the vertical extension member and a surface of non-slip clamp,
and
under a condition the depressible bar is depressed, the suspended coupled device is elevatable or lowerable so as to be trimmed and plumbed at a permanent mounting elevation.

2. The mechanical trimming tool of claim 1, wherein at least one of the exterior surfaces of the elongated horizontal structure and the vertical extension members have a channel that is sized to receive at least a portion of a cable segment of the suspension cable system.

3. The mechanical trimming tool of claim 2, wherein the portion of the cable segment of the suspension cable system is received from below.

4. The mechanical trimming tool of claim 1, further comprising fasteners that couple the portions of cable segments for each of the at least two couplers above either of the at least two couplers.

5. The mechanical trimming tool of claim 1, wherein the mechanical trimming tool is removable and reusable.

6. The mechanical trimming tool of claim 5, wherein at least a portion of the suspension cable that extends across the exterior surfaces of the elongated horizontal structure and the vertical extensions is cuttable and discardable without compromising a permanent positioning of the suspended coupled device.

7. The mechanical trimming tool of claim 1, wherein the mechanical trimming tool is configured to be operated by with a single hand of an installer.

8. A system for mounting a coupled device using a mechanical trimming tool for dual mounting device attachment to a structure, the system comprises:
a structure that supports a weight of the coupled device from two mounting points, the coupled device being a mechanical or electromechanical device;
an elongated horizontal structure with vertical extension members positioned at the opposite ends of the elongated horizontal structure, wherein the vertical extensions terminate at each end with a substantially horizontal tab, the elongated horizontal structure is disposed over the at least two mounted device couplers;
at least two mounted device couplers each having a passthrough opening, the at least two couplers are set apart from one another and configured to be coupled to the mechanical or electromechanical device mounted below;
a suspension cable system that is coupled to the at least two mounted device couplers, cable segments of the cable suspension system respectively extend through the passthrough of a corresponding one of the at least two mounted device couplers, at least one passthrough opening in the substantially horizontal tab is sized to receive at least one cable segment from one of the at least two mounted device couplers below, at least another passthrough opening in the substantially horizontal tab is sized to receive at least another cable segment from above, at least one cable segment from one of the at least two mounted device couplers below extends across exterior surfaces of the elongated horizontal structure and the vertical extension members;
a depressible horizontal bar exerts lateral pressure on at least one mechanical pressure exerting latching device that is oriented perpendicularly and extends across a vertical extension member, the at least one mechanical pressure exerting latching device has a non-slip surface that presses against the exterior surface of a vertical extension member, at least one cable segment is positioned between the exterior surface of one of the vertical extension members and a non-slip clement, the non-slip surface of the at least one mechanical pressure exerting latching device is configured to maintain the coupled suspended device in a stationary state, and
an orientation of the coupled device is set by orientation of the two mounting points, and the elevation setting, trimming, and plumbing are set via application of pressure on the depressible bar to raise or lower the coupled device to a permanent mounting elevation.

9. The system of claim 8, further comprising a removable non-slip clamp that maintains a position of the coupled device to be stationary and is removable after fasteners are coupled to at least two segments of the suspension cable at each of the at least two mounted device couplers.

10. The system of claim 8, wherein the anti-slip clamp is reusable after being removed and the mechanical or electromechanical device is set at a specified mounting height.

11. The system of claim 8, wherein at least a portion of the suspension cable that extends across the exterior surfaces of the elongated horizontal structure and the vertical extensions is cuttable and discardable without compromising a permanent positioning of the suspended coupled device.

12. The system of claim 8, wherein the suspension cable system comprises a single suspension cable to suspend the coupled device by two mounting points from a structure.

13. The system of claim 8, wherein the suspension cable system comprises:
a primary cable coupled to the coupled device and is configured to support a load of the coupled device, and
a secondary cable coupled to the coupled device and is configured to at least support the load under a condition the primary cable fails.

14. The system of claim 8, wherein a horizontal distance between the at least two mounted device couplers is equal to or smaller than a horizontal distance between the two mounting points at which the suspension cable system couples to the support structure.

15. A system for mounting a coupled device using a mechanical trimming tool for dual mounting device attachment to a structure, the system comprises:
a structure that supports a weight of the coupled device from two mounting points, the coupled device being a mechanical or electromechanical device;
an elongated horizontal structure with vertical extension members positioned at the opposite ends of the elongated horizontal structure, wherein the vertical extensions terminate at each end with a substantially horizontal tab;
an orientation specific mounting hub coupled to at least two mounted device couplers each having a passthrough opening, the at least two couplers are set apart from one another and configured to be coupled to a mechanical or electromechanical device mounted below;
a suspension cable system that is coupled to the at least two mounted device couplers, cable segments of the cable suspension system respectively extend through the passthrough of a corresponding one of the at least two mounted device couplers;
an elongated horizontal structure disposed over the at least two mounted device couplers and below the support structure, at least one passthrough opening in the mechanical trimming tool receives at least one cable segment from a coupler above, at least another passthrough opening receives at least cable segment from below that extends across exterior surfaces of the elongated horizontal structure and the vertical extension members;
a depressible horizontal bar exerts lateral pressure on at least one mechanical pressure exerting latching device that is oriented perpendicularly and extends across a vertical extension and has a non-slip surface that presses against the exterior surface of one of the vertical extension members, at least one cable segment received from above and another cable segment received from below is positioned between the exterior surface of one of the vertical extension members and a non-slip element, the non-slip surface of the at least one mechanical pressure exerting latching device is configured to maintain the coupled device in a stationary state, and
an orientation of the coupled device is set by the two points of mounting and rotation of the orientation specific hub with respect to a room configuration, like device, and/or device optical distribution, and
an elevation setting, trimming, and plumbing are set via application of pressure on the depressible bar to make the coupled device raisable or lowerable to a permanent mounting elevation.

16. The system of claim 15, further comprising a removable non-slip clamp that maintains a position of the coupled device stationary and is removable after fasteners are coupled to at least two segments of the suspension cable at each of the at least two mounted device couplers.

17. The system of claim 15, wherein the mechanical trimming tool is removable and reusable.

18. The system of claim 15, wherein the suspension cable system comprises a single suspension cable to suspend the coupled device by two mounting points from a structure.

19. The system of claim 15, wherein a two point mounting of the coupled device and a corresponding two point mounting at a support structure maintain an orientation of the coupled device.

20. The system of claim 15, wherein the at least two mounted device couplers coupled to the orientation specific hub are positioned in relation to the horizontal center of gravity of the coupled device.
